(19) United States
(12) Patent Application Publication
(10) Pub. No.: US 2019/0022783 A1
(43) Pub. Date: Jan. 24, 2019

(54) METHOD FOR FORMING A TURBINE COMPONENT

(71) Applicant: GENERAL ELECTRIC COMPANY, Schenectady, NY (US)

(72) Inventor: Dechao LIN, Greer, SC (US)

(21) Appl. No.: 15/653,015

(22) Filed: Jul. 18, 2017

(51) Int. Cl. B23K 9/00; B33Y 10/00; B23K 9/04; B23K 15/00; B23K 26/342; B23K 26/34; F01D 9/02; F23R 3/00

(52) U.S. Cl. CPC B23K 9/0026; B33Y 10/00; B23K 9/044; B23K 15/0006; B23K 2201/001; B23K 26/342; B23K 26/34; F01D 9/023; F23R 3/002; B23K 15/0086

(57) ABSTRACT

A method for forming a turbine component is disclosed, including applying a metal composition to a structure by an additive manufacturing technique and lengthening the structure by the additive manufacturing technique. The structure is a transition piece or a combustion liner-transition piece assembly. Lengthening the structure forms a structure extension. A picture frame is formed on an outer surface of the structure extension by the additive manufacturing technique.

### FIELD OF THE INVENTION

The present invention is directed to methods for forming a turbine component. More particularly, the present invention is directed to methods for forming a turbine component including forming a picture frame by an additive manufacturing technique.

### BACKGROUND OF THE INVENTION

Gas turbine unibody components may be manufactured by a complex process in which a combustion liner is formed, a transition piece is formed, a picture frame is formed, and the combustion liner, transition piece, and picture frame are joined together, but way of example, with circumferential welding by techniques such as plasma arc welding, keyhole gas tungsten arc welding, and electron beam welding. The picture frame is formed as a separate component from the transition piece or the combustion liner-transition piece assembly prior to the picture frame being joined to the transition piece or the combustion liner-transition piece assembly.

### BRIEF DESCRIPTION OF THE INVENTION

In an exemplary embodiment, a method for forming a turbine component includes applying a metal composition to a structure by an additive manufacturing technique and lengthening the structure by the additive manufacturing technique. The structure is a transition piece or a combustion liner-transition piece assembly. Lengthening the structure forms a structure extension. A picture frame is formed on an outer surface of the structure extension by the additive manufacturing technique.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF THE DRAWINGS

FIG. 1 is a perspective view of a structure, according to an embodiment of the present disclosure.

FIG. 2 is a perspective view of the structure of FIG. 1 during application of a metal composition to form a structure extension, according to an embodiment of the present disclosure.

FIG. 3 is a perspective view of the structure of FIG. 2 having the structure extension, according to an embodiment of the present disclosure.

FIG. 4 is a perspective view of the metal article of FIG. 3 during formation of a picture frame on the structure extension, according to an embodiment of the present disclosure.

FIG. 5 is a perspective view of a turbine component, according to an embodiment of the present disclosure.

Wherever possible, the same reference numbers will be used throughout the drawings to represent the same parts.

### DETAILED DESCRIPTION OF THE INVENTION

Provided are exemplary methods for forming a turbine component. Embodiments of the present disclosure, in comparison to methods not utilizing one or more features disclosed herein, decrease costs, increase process control, simplify the fabrication, increase process efficiency, increase process speed, decrease process complexity, or combinations thereof.

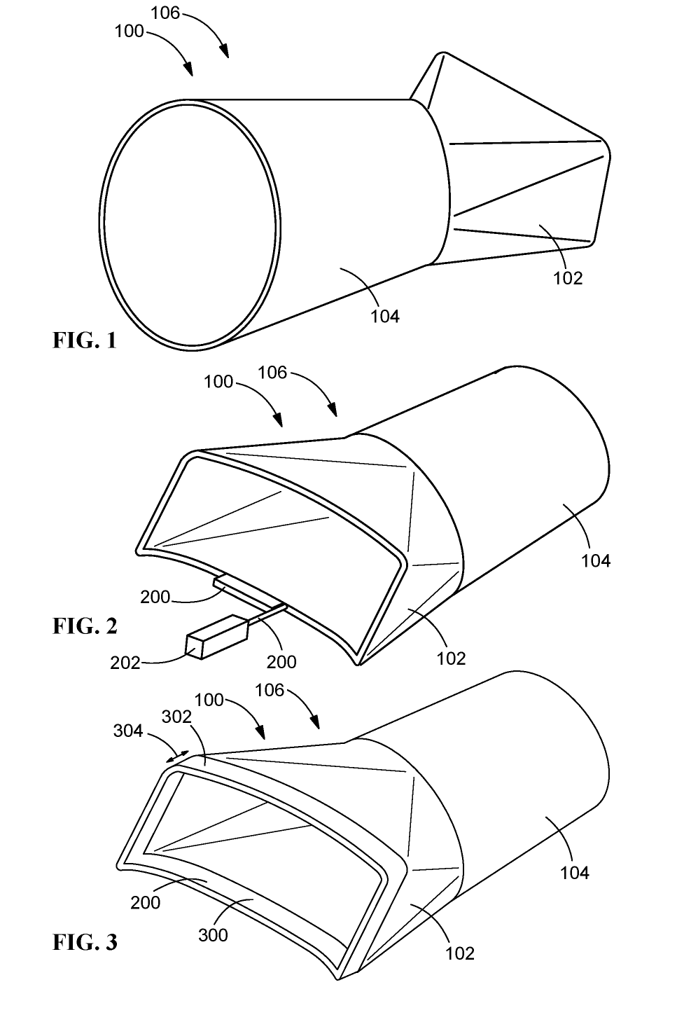

Referring to FIGS. 1-5, in one embodiment, a method for forming a turbine component 500 includes applying a metal composition 200 to a structure 100 by an additive manufacturing technique. The structure 100 is lengthened by the additive manufacturing technique. Lengthening the structure 100 forms a structure extension 300, and a picture frame 400 is formed on an outer surface 302 of the structure extension 300 by the additive manufacturing technique. The structure 100 is a transition piece 102 or a combustion liner-transition piece assembly 106. As used herein, a combustion liner-transition piece assembly 106 refers to a transition piece 102 joined to or formed integrally with a combustion liner 104, and is also known as a unibody body. In a further embodiment, the turbine component 500 is a unibody 502.

Forming the turbine component 500 may be free of circumferential welding joining the picture frame 400 to the structure 100, free of plasma arc welding joining the picture frame 400 to the structure 100, free of keyhole gas tungsten arc welding joining the picture frame 400 to the structure 100, free of electron beam welding joining the picture frame 400 to the structure 100, or combinations thereof.

Lengthening the structure 100 and forming the picture frame 400 may have any suitable duration from the commencement of applying the metal composition 200 to the structure 100 to form the structure extension through forming the picture frame 400, including, but not limited to, a duration of less than about 2 hours, alternatively a duration of less than about 1.5 hours, alternatively a duration of less than about 1 hour, alternatively a duration of less than about 0.5 hours. In one embodiment, the duration is inclusive of the finished formation of the turbine component 500.

Referring to FIG. 1, the structure 100 may include any suitable structure composition, including, but not limited to, HAYNES 188, HAYNES 230, HAYNES 263, HAYNES 282, HASTELLOY X, and combinations thereof.

As used herein, “HAYNES 188” refers to an alloy including a composition, by weight, of about 22% chromium, about 22% nickel, about 0.1% carbon, about 3% iron, about 1.25% manganese, about 0.35% silicon, about 14% tungsten, about 0.03% lanthanum, and a balance of cobalt. HAYNES 188 is available from Haynes International, 1020 W, Park Avenue, Kokomo, Ind. 46904.

As used herein, “HAYNES 230” refers to an alloy including a composition, by weight, of about 22% chromium, about 2% molybdenum, about 0.5% manganese, about 0.4% silicon, about 14% tungsten, about 0.3% aluminum, about 0.1% carbon, about 0.02% lanthanum, and a balance of nickel. HAYNES 230 is available from Haynes International, 1020 W, Park Avenue, Kokomo, Ind. 46904.

As used herein, “HAYNES 263” refers to an alloy including a composition, by weight, of about 20% chromium, about 20% cobalt, about 5.9% molybdenum, about 2.2% titanium, about 0.5% aluminum. and a balance of nickel. HAYNES 263 is available from Haynes International, 1020 W, Park Avenue, Kokomo, Ind. 46904.

As used herein, “HAYNES 282” refers to an alloy including a composition, by weight, of about 20% chromium, about 10% cobalt, about 8.5% molybdenum, about 2.1% titanium, about 1.5% aluminum, about 0.06% carbon, about 0.005% boron, up to about 1.5% iron, and a balance of nickel. HAYNES 282 is available from Haynes International, 1020 W, Park Avenue, Kokomo, Ind. 46904.

As used herein, “HASTELLOY X” refers to an alloy including a composition, by weight, of about 22% chromium, about 18% iron, about 9% molybdenum, about 1.5% cobalt, about 0.1% carbon, about 0.6% tungsten, and a balance of nickel. HASTELLOY X is available from Haynes International, 1020 W, Park Avenue, Kokomo, Ind. 46904.

Referring to FIG. 2, the metal composition 200 may be applied to the structure 100 by any suitable device 202. Applying the metal composition 200 to the structure 100 by the additive manufacturing technique may include any suitable technique, including, but not limited to, an additive welding technique. Suitable additive welding techniques may include, but are not limited to, gas metal arc welding, gas tungsten arc welding with metal filler, laser cladding with filler metal, laser melting with filler metal, electron beam melting with filler metal, direct metal laser melting, and combinations thereof. The additive welding technique may be a manual additive welding technique or a robotic additive welding technique.

The metal composition 200 may be any suitable material composition, including, but not limited to, HAYNES 188, HAYNES 230, HAYNES 263, HAYNES 282, HASTELLOY X, and combinations thereof. The metal composition 200 may be an identical material to the structure composition or may be a distinct material from the structure composition.

Referring to FIGS. 2 and 3, in one embodiment, forming the structure extension 300 includes forming the structure extension to be between about 0.1 inches to about 2 inches in length 304, alternatively between about 0.1 inches to about 1.5 inches in length 304, alternatively between about 0.1 inches to about 1 inch in length 304, alternatively between about 0.5 inches to about 1.5 inches in length 304, alternatively between about 1 inch to about 2 inches in length 304, alternatively between about 1.1 inches to about 1.9 inches in length 304, alternatively between about 1.2 inches to about 1.8 inches in length 304, alternatively between about 1.3 inches to about 1.7 inches in length 304, alternatively between about 1.4 inches to about 1.6 inches in length 304, alternatively about 1.5 inches in length 304.

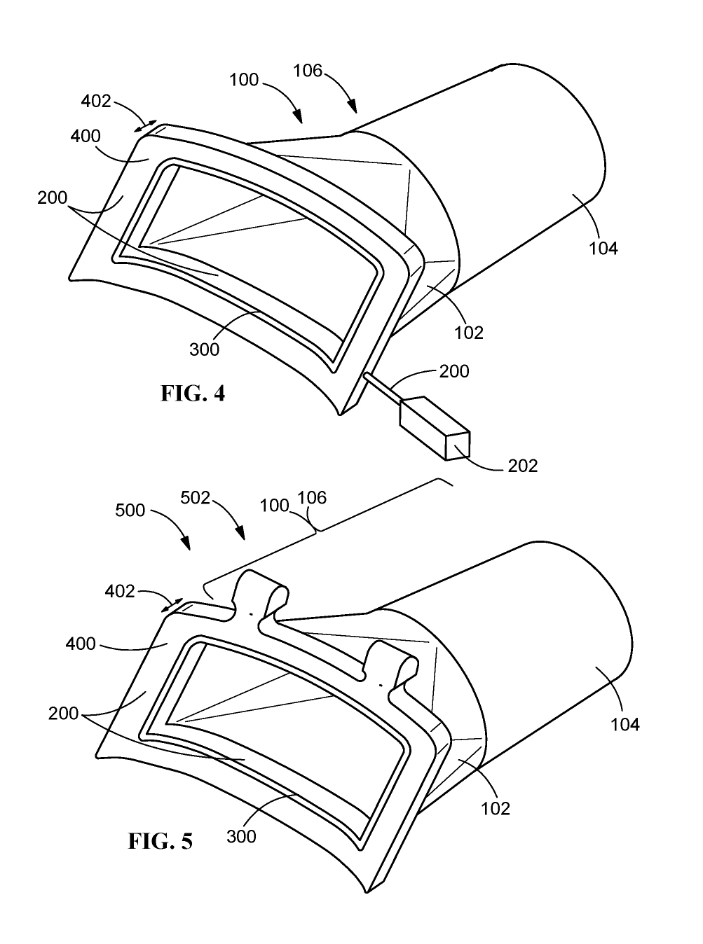

Referring to FIGS. 4 and 5, forming the picture frame 400 on the outer surface 302 of the structure extension 300 by the additive manufacturing technique may include applying the metal composition 200 by the same additive manufacturing technique used for applying the metal composition 200 to the structure 100 to form the structure extension 300 or a distinct additive manufacturing technique from the additive manufacturing technique used for applying the metal composition 200 to the structure 100 to form the structure extension 300. Further forming the picture frame 400 on the outer surface 302 of the structure extension 300 by the additive manufacturing technique may include applying the same material composition for the metal composition 200 as applied to the structure 100 to form the structure extension 300 or a distinct material composition from the metal composition 200 as applied to the structure 100 to form the structure extension 300.

In one embodiment, the picture frame 400 is formed by the additive manufacturing technique to net shape. In another embodiment, the picture frame 400 is formed by the additive manufacturing technique to near-net shape, and is then finished to near net shape. In yet another embodiment, the picture frame 400 is formed by the additive manufacturing technique to rough shape, and is then finished to near net shape. Finishing the picture frame 400 may include any suitable finishing technique, including, but not limited to, machining, polishing, abrasive blasting, burnishing, peening, electropolishing, grinding, etching, buffing, and combinations thereof.

Forming the picture frame 400 may include forming the picture frame 400 with any suitable picture frame thickness 402, including, but not limited to, a picture frame thickness 402 between about 1.2 inches to about 1.5 inches, alternatively between about 1.2 inches to about 1.3 inches, alternatively between about 1.3 inches to about 1.4 inches, alternatively between about 1.4 inches to about 1.5 inches, alternatively about 1.35 inches.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for forming a turbine component, comprising:
applying a metal composition to a structure by an additive manufacturing technique;
lengthening the structure by the additive manufacturing technique, lengthening the structure forming a structure extension; and
forming a picture frame on an outer surface of the structure extension by the additive manufacturing technique,
wherein the structure is a transition piece or a combustion liner-transition piece assembly.

2. The method of claim 1, wherein the turbine component is a unibody.

3. The method of claim 1, wherein the additive manufacturing technique includes an additive welding technique.

4. The method of claim 3, wherein the additive welding technique is selected from the group consisting of gas metal arc welding, gas tungsten arc welding with metal filler, laser cladding with filler metal, laser melting with filler metal, electron beam melting with filler metal, direct metal laser melting, and combinations thereof.

5. The method of claim 4, wherein the additive welding technique is a robotic additive welding technique.

6. The method of claim 1, further including finishing the picture frame to net shape.

7. The method of claim 1, wherein forming the structure extension includes forming the structure extension to be between about 1 to about 2 inches in length.

8. The method of claim 7, wherein the structure extension is about 1.5 inches in length.

9. The method of claim 1, wherein lengthening the structure and forming the picture frame includes a duration of less than about 1.5 hours.

10. The method of claim 9, wherein the duration is less than about 1 hour.

11. The method of claim 1, wherein the metal composition is an identical material to the structure.

12. The method of claim 1, wherein the metal composition is a distinct material from the structure.

13. The method of claim 1, wherein the metal composition is selected from the group consisting of HAYNES 188, HAYNES 230, HAYNES 263, HAYNES 282, HASTELLOY X, and combinations thereof.

14. The method of claim 1, wherein the structure includes a structure composition selected from the group consisting of HAYNES 188, HAYNES 230, HAYNES 263, HAYNES 282, HASTELLOY X, and combinations thereof.

15. The method of claim 1, wherein forming the turbine component is free of circumferential welding joining the picture frame to the structure.

16. The method of claim 1, wherein forming the turbine component is free of plasma arc welding joining the picture frame to the structure.

17. The method of claim 1, wherein forming the turbine component is free of keyhole gas tungsten arc welding joining the picture frame to the structure.

18. The method of claim 1, wherein forming the turbine component is free of electron beam welding joining the picture frame to the structure.

19. The method of claim 1, wherein forming the picture frame includes forming the picture frame with a picture frame thickness of between about 1.2 inches to about 1.5 inches.

20. The method of claim 19, wherein the picture frame thickness is about 1.35 inches.
